(19) United States
(12) Patent Application Publication
(10) Pub. No.: US 2026/0229207 A1
(43) Pub. Date: Aug. 6, 2026

(54) METHOD, APPARATUS AND ELECTRONIC DEVICE FOR AUDIO PROCESSING

(71) Applicants: DOUYIN VISION CO., LTD., Shijingshan District, Beijing (CN); Lemon Inc., Grand Cayman (KY)

(72) Inventors: Naihan Li, Beijing (CN); Yuanzhe Chen, Beijing (CN); Dongya Jia, Beijing (CN); Weisi Wang, Beijing (CN); Lei Huang, Beijing (CN); Kangmian She, Beijing (CN); Xiaochan Wang, Beijing (CN); Bochen Li, Los Angeles, CA (US); Ju-Chiang Wang, Los Angeles, CA (US); Yun-Ning Hung, Los Angeles, CA (US)

(21) Appl. No.: 18/995,661

(22) PCT Filed: Aug. 17, 2023
(86) PCT No.: PCT/CN2023/113612

§ 371 Date: Jan. 16, 2025

(30) Foreign Application Priority Data
Sep. 26, 2022 (CN) 202211177547.X

(51) Int. Cl. G10H 1/00; G10H 1/38

(52) U.S. Cl. CPC G10H 1/0025; G10H 1/38; G10H 2210/005; G10H 2210/056; G10H 2210/066; G10H 2210/105; G10H 2210/111; G10H 2210/325; G10H 2210/571; G10H 2220/096; G10H 2220/116

(57) ABSTRACT

A method, apparatus and electronic device for audio processing are provided, and the method includes: obtaining a first vocal (S201); generating, based on the first vocal, a second vocal of one or more voice parts associated with the first vocal, a timbre of the second vocal being a predetermined timbre (S202); and playing a target audio based on the first vocal and the second vocal of the one or more voice parts, the target audio comprising the first vocal and/or the second vocal of the one or more voice parts (S203).

### CROSS-REFERENCE

This application claims priority to Chinese Patent Application No. 202211177547. X, entitled “METHOD, APPARATUS AND ELECTRONIC DEVICE FOR AUDIO PROCESSING” filed Sep. 26, 2022, the entirety of which is incorporated herein by reference.

### FIELD

Embodiments of the present disclosure relate to the field of audio processing technologies, and in particular, to a method, an apparatus and an electronic device for audio processing.

### BACKGROUND

Chorusing without accompaniment is a singing method for singing unaccompanied through multiple people without using a musical instrument accompaniment. For example, a main player without accompaniment may sing a song, and other players may sing harmonies of different voice parts.

At present, if an audio without accompaniment chorusing is obtained in a single person singing manner, a user needs to obtain a harmonic melody of multiple voice parts of the audio and obtain a main tone song of the audio and harmonies of different voice parts by singing multiple times, thereby obtaining the audio without accompaniment singing. For example, the user may respectively sing a song, a harmony of high voice part of the song, and a harmony of middle voice part of the song and combine the singing song and the two harmonies through a terminal device to obtain a song without accompaniment chorusing. However, the above method needs to be sung multiple times to obtain the audio without accompaniment chorusing, and thus the complexity of audio obtaining is high.

### SUMMARY

The present disclosure provides a method, an apparatus and an electronic device for audio processing, which are used for solving the technical problem of high complexity of audio obtaining in the prior art.

In a first aspect, the present disclosure provides a method of audio processing, including: obtaining a first vocal; generating, based on the first vocal, a second vocal of one or more voice parts associated with the first vocal, a timbre of the second vocal being a predetermined timbre; and playing a target audio based on the first vocal and the second vocal of the one or more voice parts, the target audio including the first vocal and/or the second vocal of the one or more voice parts.

In a second aspect, the present disclosure provides an apparatus for audio processing, including an obtaining module, a generating module, and a play module. The obtaining module is configured to obtain a first vocal. The generating module is configured to generate, based on the first vocal, a second vocal of one or more voice parts associated with the first vocal. A timbre of the second vocal is a predetermined timbre. The play module is configured to play a target audio based on the first vocal and the second vocal of the one or more voice parts. The target audio includes the first vocal and/or the second vocal of the one or more voice parts.

In a third aspect, the embodiments of the present disclosure provide an electronic device, including: the memory storing computer execution instructions; the processor executing the computer execution instructions stored in the memory, to cause the processor to perform a method of audio processing according to the first aspect and various possible methods of audio processing related to the first aspect.

In a fourth aspect, the embodiments of the present disclosure provide a computer readable storage medium storing computer execution instructions that, when executed by a processor, implement a method of audio processing according to the first aspect and various possible methods of audio processing related to the first aspect.

In a fifth aspect, the embodiments of the present disclosure provide a computer program product, including a computer program which, when executed by a processor, implements a method of audio processing according to the first aspect and various possible methods of audio processing related to the first aspect.

In a sixth aspect, the embodiments of the present disclosure provide a computer program which, when executed by a processor, implements a method of audio processing according to the first aspect and various possible methods of audio processing related to the first aspect.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative effort.

FIG. 1 is a schematic diagram of an application scenario according to the embodiments of the present disclosure;

FIG. 2 is a schematic flowchart of a method of audio processing according to the embodiments of the present disclosure;

FIG. 3 is a schematic diagram of a process of obtaining a first vocal according to the embodiments of the present disclosure;

FIG. 4 is a schematic diagram of another process of obtaining a first vocal according to the embodiments of the present disclosure;

FIG. 5 is a schematic diagram of playing a target audio according to the embodiments of the present disclosure;

FIG. 6 is a schematic diagram of a process of displaying a voice part control according to the embodiments of the present disclosure;

FIG. 7 is a schematic diagram of a process of displaying a first voice part control according to the embodiments of the present disclosure;

FIG. 8 is a schematic diagram of a method for adjusting a timbre of a second vocal according to the embodiments of the present disclosure;

FIG. 9 is a schematic diagram of a play page according to the embodiments of the present disclosure;

FIG. 10 is a schematic diagram of a process of displaying a drag animation according to the embodiments of the present disclosure;

FIG. 11A is a schematic diagram of a process of playing a target audio according to the embodiments of the present disclosure;

FIG. 11B is a schematic diagram of another process of playing a target audio according to the embodiments of the present disclosure;

FIG. 12 is a schematic diagram of a method of generating a second vocal according to the embodiments of the present disclosure;

FIG. 13 is a schematic structural diagram of an apparatus for audio processing according to the embodiments of the present disclosure;

FIG. 14 is a schematic structural diagram of another apparatus for audio processing according to the embodiments of the present disclosure; and

FIG. 15 is a schematic structural diagram of an electronic device according to the embodiments of the present disclosure.

### DETAILED DESCRIPTION

Example embodiments will be described in detail here, examples of which are illustrated in the accompanying drawings. The following description relates to the accompanying drawings, in which the same numerals indicate the same or similar elements unless otherwise indicated. The implementations described in the following example embodiments do not represent all implementations consistent with the present disclosure. In contrast, they are merely examples of apparatuses and methods consistent with some aspects of the disclosure as detailed in the appended claims.

For ease of understanding, the concepts involved in the embodiments of the present disclosure are described below.

Electronic device: a device having a wireless transceiver function. The electronic device may be deployed on land, including indoor or outdoor, handheld, wearable, or vehicle-mounted; or may be deployed on a water surface (for example, a ship, etc.). The electronic device may be a mobile phone, a portable android device (PAD), a computer with a wireless transceiver function, a virtual reality (VR) electronic device, an augmented reality (AR) electronic device, a wireless terminal in industrial control, a vehicle-mounted electronic device, a wireless terminal in self-driving, a wireless electronic device in a remote medical, a wireless electronic device in a smart grid, a wireless electronic device in transportation safety, a wireless electronic device in a smart city, a wireless electronic device in a smart home, a wearable electronic device, or the like. The electronic device in the embodiments of the present disclosure may also be referred to as a terminal, user equipment (UE), an access electronic device, a vehicle-mounted terminal, an industrial control terminal, a UE unit, a UE station, a mobile station, a moving station, a remote station, a remote electronic device, a mobile device, a UE electronic device, a wireless communication device, a UE agent, or a UE device. The electronic device may also be fixed or mobile.

Singing without accompaniment: singing without accompaniment is a singing way that does not use a musical instrument for accompaniment. For example, in a process of singing without accompaniment, a main vocal may sing a song, and other players may sing the music of the song at different voice parts (for example, the music of the song at the high voice part or music of the song at the low voice part, etc.), and the effect of the vocal accompaniment is achieved by playing the music of the song at different voice parts, thereby achieving singing the song without accompaniment.

Voice part: when multiple rows of melodies are included in an audio to be played simultaneously, each row of melodies is a voice part of the audio. For example, each part is a voice part of the audio when playing a four-part harmony. For example, the audio portion of a piece of audio may include a soprano voice part, a mezzo soprano voice part, a contralto voice part, a tenor voice part, a baritone voice part, and a bass voice part, etc. It should be noted that the voice parts of the audio may also include other voice parts, which are not limited in the embodiments of the present disclosure.

Harmony: harmony is a sound combination audio composed of multiple different sounds produced simultaneously according to certain rules of chord. Optionally, the harmony may include chords and the connection of multiple chords. For example, chords are the basic material of harmony, which are obtained by combining three or more different sounds according to music theory. Chords are the vertical structure of harmony, and the connection mode of multiple chords is the lateral movement of harmony.

Timbre: timbre refers to different characteristics between waveforms associated with different sounds. For example, vibrations of different objects have different characteristics, such as piano, violin and other musical instruments with different structures, and characteristics of vibration are also different. Therefore, the timbre of musical instruments such as piano and violin are also different. For example, the timbre of sounds uttered by different people also varies.

In the related art, when obtaining the audio without accompaniment chorusing through singing by a single person, the user needs to obtain the harmony of the main tone song and the different voice parts of the audio through multiple singing, thereby obtaining the audio without accompaniment singing. For example, the user may respectively sing a main tone song of a song, a harmony of the low voice part, a harmony of the middle voice part and a harmony of the high voice part, and combine the main tone song, the harmony of the low voice part, the harmony of the middle voice part and the harmony of the high voice part through the electronic device to obtain a song without accompaniment chorusing. However, in the above method, the user needs to obtain an accurate harmony melody of multiple voice parts and needs to expertly sing a harmony corresponding to each harmony melody, so that the audio without accompaniment chorusing can be obtained through multiple singing, resulting in higher complexity of audio obtaining.

In order to solve technical problems in the related art, the embodiments of the present disclosure provide a method of audio processing, the electronic device may display an audio obtaining page, and the audio obtaining page includes a recording control and/or an audio import control. In response to a touch operation on the recording control or the audio import control, the electronic device may obtain a first vocal, generate a second vocal of one or more voice parts associated with the first vocal based on the first vocal, and display a play page of the first vocal. The play page includes one or more voice part controls and a play control. In response to a touch operation on the one or more voice part controls, the electronic device may display the one or more voice part controls based on a first display mode and play the target audio in response to a touch operation on the play control. The target audio includes the first vocal and/or the second vocal associated with the one or more voice part controls. In this way, if the user clicks a voice part control, the voice part control can be highlighted, so that the display effect is improved. Since the electronic device can generate a vocal of the plurality of voice parts associated with the first vocal based on the first vocal, singing without accompaniment does not require the user to perform harmony singing multiple times, the user experience is improved, and the complexity of audio obtaining is reduced.

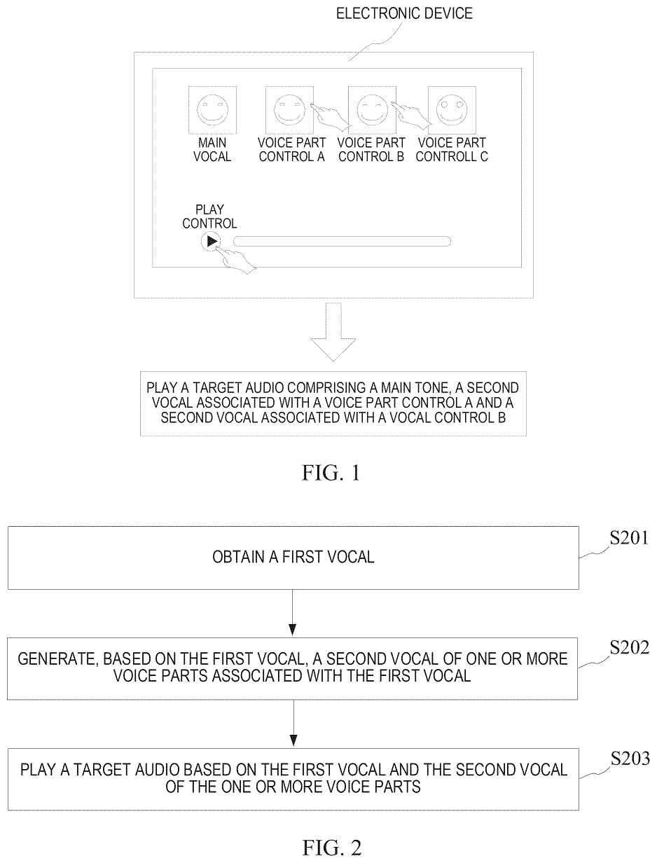

The following describes an application scenario of the embodiments of the present disclosure with reference to FIG. 1.

FIG. 1 is a schematic diagram of an application scenario according to the embodiments of the present disclosure. Referring to FIG. 1, an electronic device is included. The display page of the electronic device is a play page of music. The play page includes a main vocal control (a main tone song control of music), a voice part control A, a voice part control B, a voice part control C, and a play control. If the user clicks the play control, the voice part control A, and the voice part control B, the electronic device plays the target audio. The target audio includes a main tone of the music, a second vocal associated with the voice part control A, and a second vocal associated with the voice part control B. In this way, if the user clicks a voice part control, the electronic device may play the target audio including the first vocal and the second vocals associated with the voice part controls, and the user does not need to perform harmony singing multiple times to obtain the target audio without accompaniment singing, thereby improving the user experience and reducing the complexity of audio obtaining.

Technical solutions of the present disclosure and how the technical solutions of the present disclosure solve the aforementioned technical problems are described in detail below with reference to specific embodiments. The following several specific embodiments may be combined with each other, and the same or similar concepts or processes may not be repeated in some embodiments. The embodiments of the present disclosure will be described below with reference to the accompanying drawings.

FIG. 2 is a schematic flowchart of a method of audio processing according to the embodiments of the present disclosure. Referring to FIG. 2, the method may include the following steps.

At step S201, obtain a first vocal.

The executing body of the embodiments of the present disclosure is an electronic device or an apparatus for audio processing set in the electronic device. The apparatus for audio processing may be implemented by software, and the apparatus for audio processing may also be implemented by combining software and hardware.

Optionally, the first vocal may be a song. For example, the first vocal may be a song sung by the user in real time, and the first vocal may also be a song stored in a database of the electronic device. Optionally, the first vocal may be a song without accompaniment. For example, the first vocal may be a song sung by the user unaccompanied.

Optionally, the electronic device may obtain the first vocal based on the following feasible implementations: displaying an audio obtaining page including a recording control and/or an audio import control and obtaining the first vocal in response to a touch operation on the recording control or the audio import control. For example, the electronic device may display an audio obtaining page, where the audio obtaining page may include a recording control, and the user performs a touch operation on the recording control, so that the electronic device obtains the first vocal. For example, the electronic device may display an audio obtaining page, where the audio obtaining page may include an audio import control, and the user performs a touch operation on the audio import control, so that the electronic device obtains the first vocal. It should be noted that the audio obtaining page may also include a recording control and an audio import control, which is not limited in the embodiments of the present disclosure.

Optionally, the electronic device may display the audio obtaining page in response to the user's operation on an audio processing application. For example, an audio processing application may be installed in the electronic device. If the user clicks the icon of the audio processing application on the screen of the electronic device, the electronic device may display the audio obtaining page. Optionally, the user may input a website address associated with the audio processing application in the browser of the electronic device, so that the electronic device displays the audio obtaining page. It should be noted that the electronic device may also display the audio obtaining page in other manners, which is not limited in the embodiments of the present disclosure.

Optionally, in response to a touch operation on the recording control or the audio import control, the first vocal is obtained, and there are the following two feasible implementations.

A feasible implementation is as follows.

In response to a touch operation on the audio import control, an audio import page is displayed. Optionally, the audio import page includes an audio file associated with the first vocal. For example, if the user clicks the audio import control in the audio obtaining page, the electronic device may display an audio import page including a plurality of audio files, and each audio file is associated with a first vocal.

Optionally, the first vocal is obtained in response to a touch operation on the audio file. For example, an audio uploading page includes an audio file A and an audio file B. If the user clicks the audio file A, the electronic device may determine an audio associated with the audio file A as the first vocal. If the user clicks the audio file B, the electronic device may determine an audio associated with the audio file B as the first vocal.

Optionally, the audio file may be an audio file pre-recorded by the user. For example, the user may record, by using the electronic device, a plurality of songs singing unaccompanied and save the file of the song to the electronic device. If the electronic device displays the audio import page, the audio import page may include audio files of a plurality of songs singing unaccompanied pre-recorded by the user.

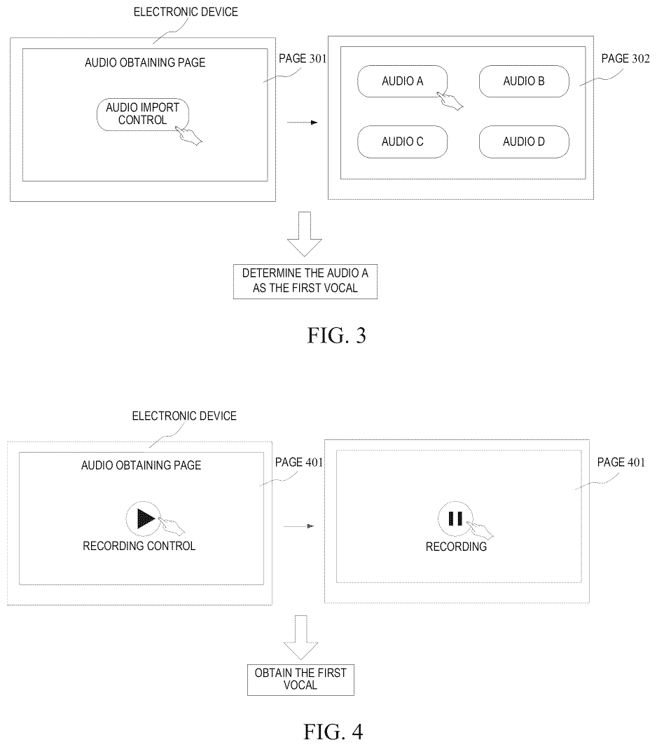

In the following, with reference to FIG. 3, in this implementation, a process of obtaining a first vocal is described.

FIG. 3 is a schematic diagram of a process of obtaining a first vocal according to the embodiments of the present disclosure. Referring to FIG. 3, an electronic device is included. The display page of the electronic device includes a page 301 and page 302. The page 301 is an audio obtaining page. The audio obtaining page includes an audio import control. If the user clicks the audio import control, the electronic device jumps from the page 301 to the page 302.

Referring to the page 302, the page 302 is an audio import page. The page 302 includes a file of an audio A, a file of an audio B, a file of an audio C, and a file of an audio D. If the user clicks the file of the audio A, the electronic device determines the audio A as the first vocal.

Another feasible implementation is as follows.

The vocal uttered by the user is recorded in response to a touch operation on the recording control. For example, if the user clicks the recording control, the electronic device may receive the voice uttered by the user and record the voice. Optionally, the recording control includes a recording state and a stop-recording state. For example, if the electronic device records the vocal uttered by the user, the state of the recording control is the recording state. If the electronic device stops recording the vocal uttered by the user, the state of the recording control is the stop-recording state.

Optionally, if the state of the recording control is different, the style of the recording control is different. For example, if the state of the recording control is the recording state, the style of the recording control is a first style. If the state of the recording control is the stop-recording state, the style of the recording control is a second form, so that the user can accurately determine whether the electronic device is recording the vocal uttered by the user through the style of the recording control, thereby improving the accuracy of audio obtaining and the user experience.

In response to a touch operation on the recording control, the vocal uttered by the user is stopped recording to obtain the first vocal. For example, if the state of the recording control is the recording state and the user performs the touch operation on the recording control, the electronic device stops recording the vocal uttered by the user. For example, if the user clicks the recording control, the electronic device starts to collect the song sung by the user. If the user finishes the singing, the user clicks the recording control again, the electronic device stops collecting the song sung by the user and determines the collected song sung by the user as the first vocal.

In the following, with reference to FIG. 4, in this implementation, a process of obtaining a first vocal is described.

FIG. 4 is a schematic diagram of another process of obtaining a first vocal according to the embodiments of the present disclosure. Referring to FIG. 4, an electronic device is included. The display page of the electronic device includes a page 401. The page 401 is an audio obtaining page. The audio obtaining page includes a recording control. If the user clicks the recording control, the style of the recording control changes. The electronic device may record the voice uttered by the user. If the user clicks the recording control again, the style of the recording control changes again, and the electronic device may obtain the first vocal.

Optionally, the play page may include a tuning control, and after the electronic device obtains the first vocal, in response to a touch operation on the tuning control, the electronic device may perform tuning on the first vocal, so that the singing of the user is more harmonious, the requirement for the user's singing skills is reduced, and then the complexity of audio obtaining is reduced.

At S202: generate, based on the first vocal, a second vocal of one or more voice parts associated with the first vocal.

Optionally, a timbre of the second vocal is a preset timbre. For example, the timbre of the second vocal may be a contralto, a soprano, a bass, a tenor, and the like. The timbre of the second vocal may also be another timbre, which is not limited in the embodiments of the present disclosure.

Optionally, the first vocal may be associated with a second vocal of the at least one voice part. Optionally, the voice part associated with the first vocal may include a low voice part, a middle low voice part, a middle voice part, a middle high voice part, and a high voice part. For example, second vocals associated with the first vocal may include a second vocal of the first vocal in the high voice part and a second vocal of the first vocal in the low voice part. It should be noted that the low voice part, the middle voice part and the high voice part in the embodiments of the present disclosure are merely examples for describing pitch, and the pitch is not limited, and the pitches of the low voice part, the middle voice part and the high voice part may be preset pitches, which are not limited in the embodiments of the present disclosure.

Optionally, the electronic device may generate the second vocals of the one or more voice parts associated with the first vocal based on a feasible implementation: determining, based on the first vocal, a harmony melody associated with the voice part, and generating the second vocal of the voice part based on the first sound and the harmony melody. For example, the electronic device may obtain an accompaniment chord of the first vocal, recombine the accompaniment chord based on the voice part, to obtain the harmonic melody of the voice part, and tune the first vocal to the harmony melody to obtain the second vocal corresponding to the voice part.

At S203: play a target audio based on the first vocal and the second vocal of the one or more voice parts.

Optionally, the target audio includes the first vocal and/or the second vocal(s) of the one or more voice parts. For example, the target audio may only include the first vocal, and the target audio may also include the first vocal and the second vocals of the plurality of voice parts, which is not limited in the embodiments of the present disclosure.

Optionally, an audio text of the first vocal and an audio text of the second vocal are the same. For example, if the first vocal is a piece of song, the second vocal is also a piece of song, and a lyric of the first vocal and a lyric of the second vocal are the same.

Optionally, the electronic device may play the target audio based on a feasible implementation as follows: displaying a play page of the first vocal. Optionally, the play page includes one or more voice part controls and a play control. Optionally, the play control is configured to play the target audio. For example, if the user clicks the play control, the electronic device may play the target audio. If the target audio is played and the user clicks the play control, the electronic device may stop playing the target audio.

Optionally, a voice part control is configured to control the second vocal. For example, the voice part control may control whether the target audio includes the second vocal corresponding to the voice part control. For example, the play page includes a high voice part control. If the user clicks the high voice part control, the target audio played by the electronic device includes a second vocal of the high voice part. If the user turns off the high voice part control, the target audio played by the electronic device does not include the second vocal of the high voice part.

It should be noted that, in the embodiment of the present disclosure, the play page may include at least one voice part control, and each voice part control has a corresponding first vocal. If different voice part control is touched, the second vocal included in the target audio played by the electronic device is also different. For example, the play page of the first vocal includes a low voice part control and a high voice part control. If the user clicks the low voice part control, the target audio played by the electronic device includes the second vocal of the low voice part. If the user clicks the high voice part control, the target audio played by the electronic device includes the second vocal of the high voice part.

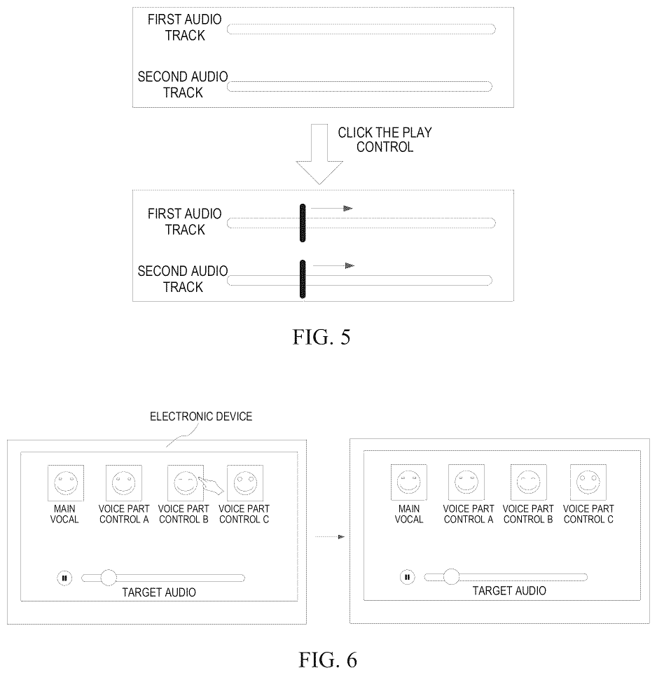

Optionally, an audio track of the first vocal and an audio track of the second vocal are in the same time period, and the process of playing the target audio is described below with reference to FIG. 5.

FIG. 5 is a schematic diagram of playing a target audio according to the embodiments of the present disclosure. Referring to FIG. 5, a first audio track of a first vocal and a second audio track of a second vocal are included. If the user clicks the play control, the electronic device may play the target audio. A play pointer in the first audio track moves to the right, and a play pointer in the second audio track moves to the right, where the position of the play pointer on the second audio track is the same as the position of the play pointer on the first audio track. In this way, the user may add the second vocal at any position of the first vocal playing, thereby improving the flexibility of audio processing.

Optionally, in response to a touch operation on the one or more voice part controls, the one or more voice part controls are displayed based on a first display mode. Optionally, the voice part control may include a first image. For example, the voice part control may include an image frame control, and the image frame control may display a static image or a dynamic image, thereby improving the display effect of the voice part control.

Optionally, the first display mode is used to highlight the first image. For example, the first display mode may be highlighting or zooming in, etc., which is not limited in the embodiments of the present disclosure. For example, if the user performs a touch operation on the voice part control, the electronic device controls the first image corresponding to the voice part control to be highlighted.

The process of displaying the voice part control in the first display mode is described below with reference to FIG. 6.

FIG. 6 is a schematic diagram of a process of displaying a voice part control according to the embodiments of the present disclosure. Referring to FIG. 6, an electronic device is included. The display page of the electronic device is a play page of the first vocal. The play page includes a main vocal control, a voice part control A, a voice part control B, a voice part control C, and a play control. The voice part control A, the voice part control B and the voice part control C are all displayed in a low brightness, and the target audio played by the electronic device includes the first vocal.

Referring to FIG. 6, if the user clicks the voice part control B, the display state of the voice part control B is switched from the low light display to the highlight display, and the target audio played by the electronic device includes the first vocal and the second vocal associated with the voice part control B. In this way, in response to the touch operation of the user on the voice part control, the display mode of the voice part control is adjusted, the flexibility of interaction may be improved, and the page display effect is improved.

Optionally, in response to a touch operation on the play control, the target audio is played. The target audio includes the first vocal and the second vocal associated with the one or more voice part controls. For example, if the user clicks the low voice part control and the high voice part control in the play page, if the user clicks the play control, the target audio played by the electronic device may include the first vocal, the second vocal of the low voice part, and the second vocal of the high voice part.

Optionally, if the electronic device plays the target audio, the electronic device may further display, in response to a touch operation on a first voice part control displayed in the first display mode, the first voice part control based on a second display mode. The target audio does not include a second vocal associated with the first voice part control. For example, the first voice part control may be a highlighted voice part control. Optionally, the second display mode is used to cancel highlighting the first image. For example, the second display mode may be a low light display or a zoom-out display, which is not limited in the embodiments of the present disclosure.

Optionally, a display brightness of the second display mode is lower than a display brightness of the first display mode. For example, the first display mode may be highlighted, and the second display mode may be low light display. For example, the user clicks the low voice part control and the high voice part control in the play page, the low voice part control and the high voice part control are highlighted, and the target audio played by the electronic device may include the first vocal, the second vocal of the low voice part, and the second vocal of the high voice part. If the user clicks the high voice part control again, the electronic device controls the high voice part control to display in the low brightness. The target audio played by the electronic device may include the first vocal and the second vocal of the low voice part, and does not include the second vocal of the high voice part.

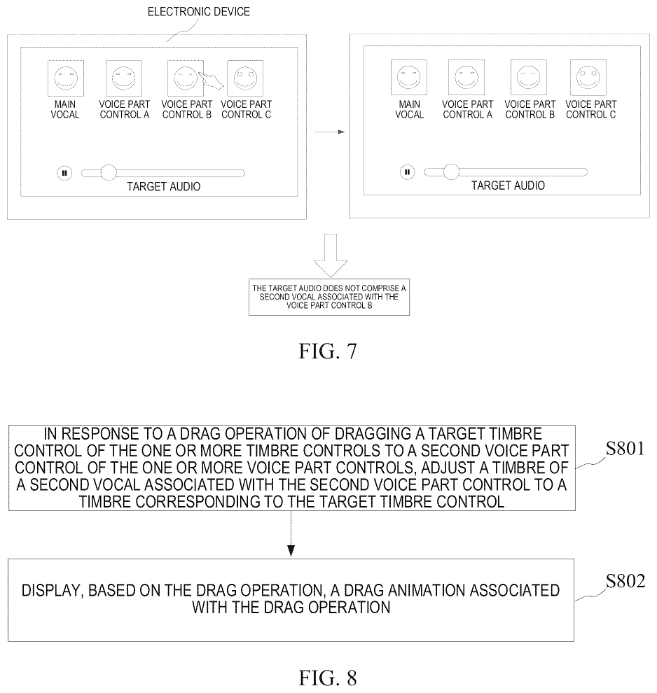

The process of displaying the first voice part control in the second display mode is described below with reference to FIG. 7.

FIG. 7 is a schematic diagram of a process of displaying a first voice part control according to the embodiments of the present disclosure. Referring to FIG. 7, an electronic device is included. The display page of the electronic device is a play page of the first vocal. The play page includes a main vocal control, a voice part control A, a voice part control B, a voice part control C, and a play control.

Referring to FIG. 7, the target audio being played by the electronic device includes the first vocal and a second vocal associated with the voice part control B. The voice part control A and voice part control C are displayed in the low brightness, and the voice part control C is displayed in the high brightness. If the user clicks the voice part control B, the display state of the voice part control B is switched from the highlight display to the low light display, and the target audio played by the electronic device does not include the second vocal associated with the voice part control B. The target audio includes the first vocal.

The embodiments of the present disclosure provide a method of audio processing, the electronic device may display an audio obtaining page including a recording control and/or an audio import control; in response to a touch operation on the recording control or the audio import control, obtain a first vocal, and generate a second vocal of one or more voice parts associated with the first vocal based on the first vocal, and display a play page of the first vocal, wherein the play page includes one or more voice part controls and a playing control. In response to a touch operation on the one or more voice part controls, the electronic device may display the one or more voice part controls based on a first display mode and play the target audio in response to a touch operation on the playing control, wherein the target audio includes the first vocal and the second vocal associated with the one or more voice part controls. In this way, if the user clicks the voice part control, the voice part control may be highlighted, so that the display effect is improved. Since the electronic device may generate the vocal of the plurality of voice parts associated with the first vocal based on the first vocal, singing without accompaniment does not require the user to perform harmony singing multiple times, the user experience is improved, and the complexity of audio obtaining is reduced.

On the basis of the embodiment shown in FIG. 2, the play page further includes a timbre control, and the above method of audio processing further includes a method for adjusting a timbre of the second vocal. The method for adjusting the timbre of the second vocal is described below with reference to FIG. 8.

FIG. 8 is a schematic diagram of a method for adjusting a timbre of a second vocal according to the embodiments of the present disclosure. Referring to FIG. 8, the method includes the following steps.

At S801: in response to a drag operation of dragging a target timbre control of the one or more timbre controls to a second voice part control of the one or more voice part controls, adjust a timbre of a second vocal associated with the second voice part control to a timbre corresponding to the target timbre control.

Optionally, the play page may include at least one timbre control, and each timbre control has a corresponding timbre. For example, the play page may include a timbre control A and a timbre control B. A timbre associated with the timbre control A may be a timbre A, and a timbre associated with the timbre control B may be a timbre B. It should be noted that a timbre associated with a timbre control may be a timbre of any user, or may be a virtual timbre, which is not limited in the embodiments of the present disclosure. For example, the electronic device may preset the timbre associated with the timbre control A as the timbre of the user A, and the timbre associated with the timbre control B is the virtual timbre.

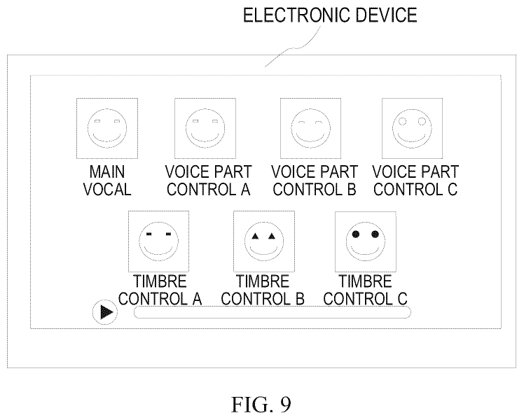

Next, with reference to FIG. 9, the voice part control and the timbre control in the play page are described.

FIG. 9 is a schematic diagram of a play page according to the embodiments of the present disclosure. Referring to FIG. 9, an electronic device is included. The display page of the electronic device is a play page for the first vocal. The play page includes a main vocal control (a main tone song control of music), a voice part control A, a voice part control B, a voice part control C, a timbre control A, a timbre control B, a timbre control C, and a play control. Each voice part control corresponds to a second vocal (for example, a vocal of the high voice part, a vocal of the middle voice part, and a vocal of the low voice part) of a voice part associated with the first vocal, and each timbre control corresponds to a timbre (for example, a soprano, a mezzo, and a bass).

Optionally, a drag operation may be a drag operation that drags a target timbre control to a second voice part control. The target timbre control may be a timbre control that the user touches. For example, the play page includes a timbre control A and timbre control B. If the user clicks the timbre control A, the target timbre control is the timbre control A. For example, the play page includes a low voice part control and high voice part control. If the user drags the target timbre control to the low voice part control, the electronic device determines the second voice part control as the low voice part control. It should be noted that the user may drag a timbre control into one voice part control, and the user may also drag a timbre control into the plurality of voice part controls, which is not limited in the embodiments of the present disclosure.

Optionally, if the user drags the target timbre control to the second voice part control, the electronic device may replace the timbre of the second vocal corresponding to the second voice part control with the timbre corresponding to the target timbre control. For example, the target audio played by the electronic device includes the first vocal and a second vocal of the soprano (timbre) of the high voice part, the timbre corresponding to the target timbre control is the tenor. If the user drags the target timbre control to the high voice part control, the electronic device replaces the timbre of the second vocal of the high voice part with the tenor, and the target audio played by the electronic device includes the first vocal and the second vocal of the tenor (timbre) of the high voice part.

Optionally, the play page of the first vocal further includes a sound phase control associated with the voice part control, and in response to the sliding operation on the sound phase control, the sound phase of the second vocal associated with the voice part control is adjusted. Optionally, the sound phase may be an acoustic channel. For example, the sound phase is adjusted to the left, the sound channel is shifted to the left, the sound phase is adjusted to the right, and the sound channel is shifted to the right.

It should be noted that the play page may further include a volume control and a sound effect control, which is not limited in the embodiments of the present disclosure.

At S802, display, based on the drag operation, a drag animation associated with the drag operation.

Optionally, the drag animation includes an animation of the timbre control. For example, the animation of the timbre control may be the second image, the timbre control may include an image control, the image control may include a dynamic image or a static image, which is not limited in the embodiments of the present disclosure. If the user clicks the timbre control, the electronic device may display the second image associated with the timbre control.

Optionally, the electronic device may display a drag animation associated with the drag operation based on a feasible implementation: in response to the drag operation, displaying an animation of the timbre control, and controlling an animation of the timbre control to move along a drag trajectory associated with the drag operation. For example, if the user clicks the timbre control, the electronic device may display an animation of the second image associated with the timbre control. If the user drags the timbre control, the second image may move along with the trajectory of the user drag, it should be noted that the timbre control may also include a static image if not clicked. If the user clicks the timbre control, the electronic device may generate a second image that is the same as the static image and control the second image to move based on the drag operation.

It should be noted that, if the play page is displayed, the electronic device may select a second vocal of any timbre for the voice part control or may not select the timbre. If the user moves the timbre control to the voice part control, the timbre of the second vocal is determined, which is not limited in the embodiments of the present disclosure.

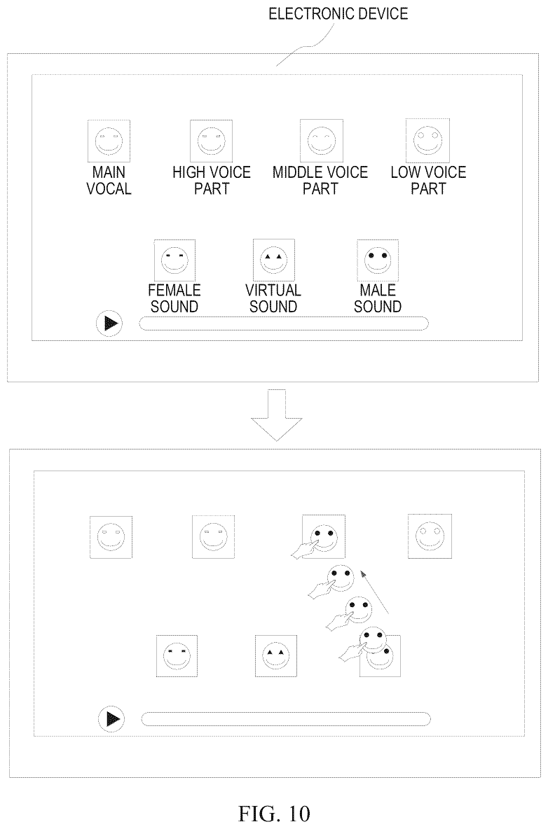

The process of displaying the drag animation is described below with reference to FIG. 10.

FIG. 10 is a schematic diagram of a process of displaying a drag animation according to the embodiments of the present disclosure. Referring to FIG. 10, an electronic device is included. The display page of the electronic device is a play page of the first vocal. The play page includes a chorus control (a main song control of music), a high voice part control, a middle voice part control, a low voice part control, a female voice part control, a virtual voice part control, a male sound and a play control.

Referring to FIG. 10, if the user clicks the male control, the electronic device may display a smiley face image associated with the male control. If the user drags the smiley face image to the middle voice part control, the electronic device may display a drag animation, where the drag animation is an animation of the smiley face image moving to the middle voice part control along with the operation of the user. If the user drags the smiley face image to the middle voice part control, the electronic device adjusts the image displayed by the middle voice part control to the image corresponding to the male voice part control.

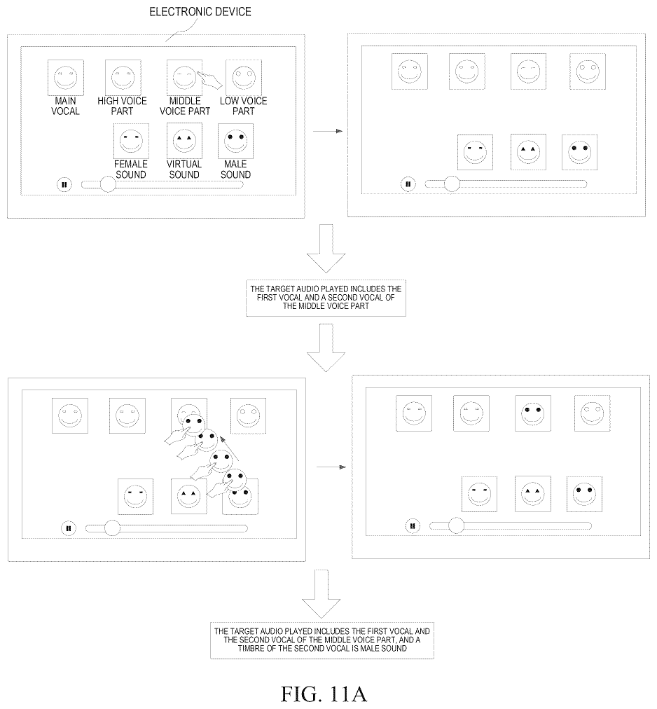

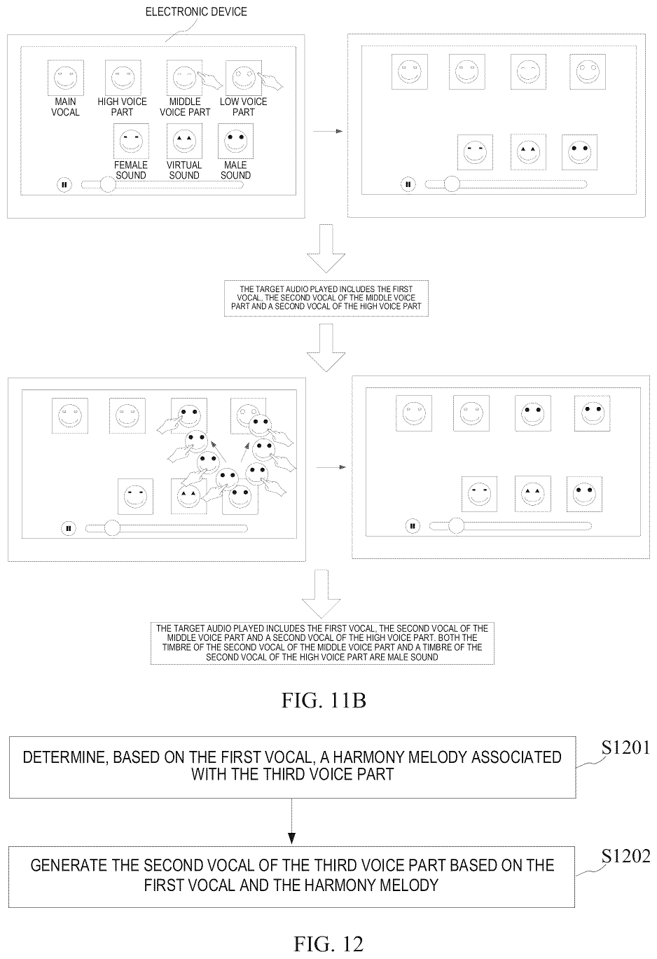

The process of playing the target audio is described below with reference to FIG. 11A to FIG. 11B.

FIG. 11A is a schematic diagram of a process of playing a target audio according to the embodiments of the present disclosure. Referring to FIG. 11A, an electronic device is included. The display page of the electronic device is a play page of the first vocal. The play page includes a main singing control, a high voice part control, a middle voice part control, a low voice part control, a female voice part control, a virtual voice part control, a male voice part control, and a play control. The high voice part control, the middle voice part control and the low voice part control are all low light display, and the target audio played by the electronic device includes the first vocal.

Referring to FIG. 11A, if the user clicks the middle voice part control, the display state of the middle voice part control is switched from the low light display to the highlight display, and the target audio played by the electronic device includes the first vocal and the second vocal of the middle voice part. If the user clicks on the male control, the electronic device may display the smiley face image associated with the male control. If the user drags the smiling face image to the middle voice part control, the smiling face image moves to the middle voice part control along with the operation of the user, and the electronic device adjusts the image displayed by the middle voice part control to the image corresponding to the man voice part control. The target audio played by the electronic device includes a first vocal and a second vocal of the middle voice part, and a timbre of the second vocal is a male sound.

FIG. 11B is a schematic diagram of another process of playing a target audio according to the embodiments of the present disclosure. Referring to FIG. 11B, an electronic device is included. The display page of the electronic device is a play page of the first vocal. The play page includes a main singing control, a high voice part control, a middle voice part control, a low voice part control, a female voice part control, a virtual voice part control, a male voice part control, and a play control. The high voice part control, the middle voice part control and the low voice part control are all low light display, and the target audio played by the electronic device includes the first vocal.

Referring to FIG. 11B, if the user clicks the middle voice part control and the low voice part control, the display state of the middle voice part control and the low voice part control is switched from the low light display to the highlight display, and the target audio played by the electronic device may include the first vocal, the second vocal of the middle voice part, and the second vocal of the low voice part. If the user clicks on the male control, the electronic device may display the smiley face image associated with the male control.

Referring to FIG. 11B, if the user drags the smiling face image to the middle voice part control, the smiling face image moves to the middle voice part control along with the operation of the user, if the user drags the smiling face image to the low voice part control, the smiling face image moves to the low voice part control along with the operation of the user, and the electronic device adjusts the image displayed by the middle voice part control and the image displayed by the low voice part control to be the image corresponding to the man voice part control, the target audio played by the electronic device may include the first vocal, the second vocal of the middle voice part, and the second vocal of the low voice part, and the timbre of the second vocal of the middle voice part and the second vocal of the low voice part is the man sound.

The embodiments of the present disclosure provide a method for changing timbre of a first and a sound, in response to a drag operation of dragging a target timbre control of one or more timbre controls to a second one of the one or more voice part control controls, adjusting a timbre of a second vocal associated with the second voice part control to a timbre corresponding to the timbre control, and displaying a drag animation associated with the drag operation based on the drag operation. In this way, the user may arbitrarily adjust the timbre of the second vocal included in the target timbre by the dragging operation on the timbre control, thereby improving the flexibility of the audio processing, and the vocal of each voice part may set the same timbre or different timbre, thereby reducing the complexity of audio obtaining and improving the efficiency of audio obtaining.

Based on any one of the foregoing embodiments, the following describes, with reference to FIG. 12, a method for generating a second vocal of the third voice part for any one of the plurality of voice parts in the foregoing method of audio processing.

FIG. 12 is a schematic diagram of a method for generating a second vocal according to the embodiments of the present disclosure. Referring to FIG. 12, the method includes the following steps.

S1201: Determine, based on the first vocal, a harmony melody associated with the third voice part.

Optionally, the melody may be a melody associated with a voice part of the first vocal. For example, in the music creation process, the target sound domain is different, the melody corresponding to the song also changes, and the harmony melody of different voice parts is different. For example, the vocal and the melody of the low voice part of the first vocal are melody A.

Optionally, the electronic device may determine the harmonic melody associated with the third voice part based on a feasible implementation as follows: obtain an accompaniment chord associated with the first vocal. For example, if the first vocal is the audio uploaded by the user through the audio import page, the electronic device may obtain the accompaniment of the first vocal, and determine the accompaniment chord in the accompaniment through the chord detection algorithm. If the first vocal is the humming audio of the user, the electronic device may obtain the melody of the audio through the melody detection algorithm, and then match the corresponding chord to the melody through the chord matching algorithm to obtain the accompaniment chord of the first vocal.

The accompaniment chord is adjusted based on the third voice part to obtain the harmony melody associated with the second vocal of the third voice part. For example, if the third voice part is a low voice part, the electronic device may reduce the chord position in the accompaniment chord to obtain the harmony melody of the low voice part; if the third voice part is a high voice part, the electronic device may improve the chord position in the accompaniment chord, and then obtain the harmony melody of the high voice part.

It should be noted that the electronic device may adjust the chord position in the accompaniment chord through the correspondence between the chord position and the voice part. For example, the chord position of the low-acoustic part and the harmonic melody is the position A, the chord position of the high-acoustic part and the harmonic melody is the position B, if the third voice part is the low-voice part, the chord position of the accompaniment chord is adjusted based on the position A. If the third voice part is the high-voice part, the chord position of the accompaniment chord is adjusted based on the position B.

At S1202: generating a second vocal of the third voice part based on the first vocal and the harmony melody.

Optionally, the electronic device may generate the second vocal of the third voice part based on the following feasible implementation: if the sound difference between the pitch associated with the harmony melody and the first pitch of the first vocal is less than or equal to the first threshold, the electronic device may sound the first vocal to the melody to obtain the second vocal of the third voice part. For example, if the pitch of the song sung by the user is similar to that of the high voice part and the pitch of the harmony melody, the electronic device may trim the song to the harmony melody word by word to obtain the second vocal of the third voice part.

Optionally, if the sound difference between the pitch associated with the harmony melody and the first pitch is greater than the first threshold, the pitch associated with the harmony melody is translated to the position of the first pitch, and the first sound is trimmed to the harmony melody to obtain the second vocal of the third voice part. For example, if the pitch of the song sung by the user differs from the pitch of the high voice part and the pitch of the harmony melody, the electronic device may translate the harmony melody of the high voice part to the position of the first pitch (or may be a similar position), and then trim the song to the harmony melody one by one to obtain the second vocal of the third voice part. In this way, if the pitch difference of the plurality of voice parts is relatively large, the harmony melody of the plurality of voice parts may be translated to the pitch position of the user, and then the sound is trimmed, thereby improving the audio processing effect, and the electronic device may record the pitch translation value of each and the harmony melody. If the timbre of the second vocal is replaced, the harmony melody may be restored to the original pitch position based on the pitch translation value.

Optionally, the electronic device may obtain the second vocal of the third voice part based on the following feasible implementation, to obtain the second vocal of the third voice part, to obtain the to-be-processed vocal. Optionally, a timbre of the to-be-processed vocal is the same as a timbre of the first vocal. For example, if the tone of the first vocal is timbre A, the tone of the person to be processed is timbre A. If the timbre of the first vocal is timbre B, the tone of the person to be processed is timbre B.

Optionally, the preset timbre is obtained, and the timbre of the vocal to be processed is replaced with the preset timbre to obtain the second vocal of the third voice part. Optionally, the preset timbre may be a timbre associated with the timbre control. For example, if the timbre associated with the timbre control is timbre A, the preset timbre may be Timbre A. If the timbre associated with the timbre control is Timbre B, the preset timbre may be Timbre B, it should be noted that the preset timbre may also be other timbre, which is not limited in the embodiments of the present disclosure. In this way, the timbre of the second vocal may be in accordance with the timbre of the third voice part, for example, if the third voice part is a high voice part, the timbre of the second vocal of the third voice part generated by the electronic device may be a female treble. If the third voice part is a low voice part, the timbre of the second vocal of the third voice part generated by the electronic device may be the subwoofer, which may improve the play effect of the second vocal, thereby improving the accuracy of audio obtaining and reducing the complexity of audio obtaining.

The embodiments of the present disclosure provide a method for obtaining first and sound, and the method includes the steps: obtaining an accompaniment chord associated with a first vocal, adjusting the accompaniment chord based on a third voice part to obtain a harmony melody associated with the second vocal of the third voice part, and generating a second vocal of the third voice part based on the first vocal and the harmony melody. In this way, the electronic device may adjust the accompaniment chord corresponding to the first vocal based on the third voice part, to obtain the harmony melody associated with the third voice part, and then trim the first vocal on the harmony melody one by one to obtain the second vocal associated with the third voice part, improve the playing effect of the second vocal, and reduce the complexity of audio obtaining.

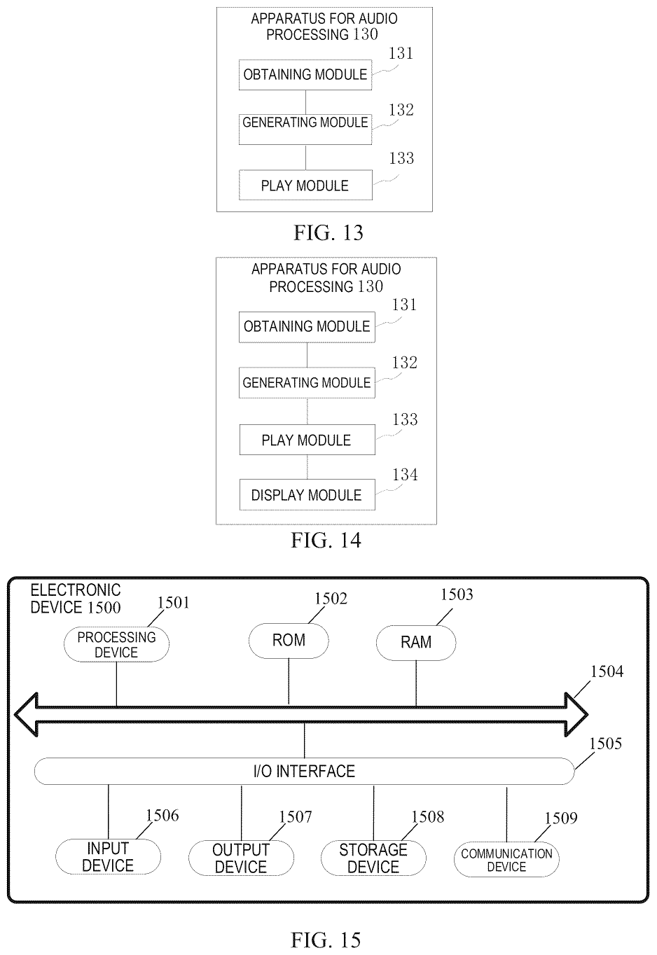

FIG. 13 is a schematic structural diagram of an apparatus for audio processing according to the embodiments of the present disclosure. Referring to FIG. 13, the apparatus for audio processing 130 includes an obtaining module 131, a generating module 132, and a play module 133.

The obtaining module 131 is configured to obtain a first vocal.

The generating module 132 is configured to generate, based on the first vocal, a second vocal of one or more voice parts associated with the first vocal, a timbre of the second vocal being a predetermined timbre.

The play module 133 is configured to play a target audio based on the first vocal and the second vocal of the one or more voice parts, the target audio including the first vocal and/or the second vocal of the one or more voice parts.

According to one or more embodiments of the present disclosure, the obtaining module 131 is specifically configured to: display an audio obtaining page including a recording control and/or an audio import control; and in response to a touch operation on the recording control or the audio import control, obtain the first vocal.

According to one or more embodiments of the present disclosure, the obtaining module 131 is specifically configured to: in response to the touch operation on the audio import control, display an audio import page including an audio file associated with the first vocal; and in response to a touch operation on the audio file, obtain the first vocal.

According to one or more embodiments of the present disclosure, the obtaining module 131 is specifically configured to: in response to a touch operation on the recording control, record a vocal uttered by a user; and in response to a touch operation on the recording control, stop recording the vocal uttered by the user to obtain the first vocal.

According to one or more embodiments of the present disclosure, the playing module 133 is specifically configured to: display a play page of the first vocal, the play page including one or more voice part controls and a play control; in response to a touch operation on the one or more voice part controls, display, based on a first display mode, the one or more voice part controls; and in response to a touch operation on the play control, play the target audio including the first vocal and the second vocal associated with the one or more voice part controls.

According to one or more embodiments of the present disclosure, the playing module 133 is further configured to: in response to a touch operation on a first voice part control displayed in the first display mode, display, based on a second display mode, the first voice part control, wherein the target audio does not include a second vocal associated with the first voice part control, and a display brightness of the second display mode is lower than a display brightness of the first display mode.

The apparatus for audio processing provided in the embodiments of the present disclosure may be configured to perform the technical solutions in the foregoing method embodiments, and implementation principles and technical effects thereof are similar, and details are not described herein again in this embodiment.

FIG. 14 is a schematic structural diagram of another apparatus for audio processing according to the embodiments of the present disclosure. On the basis of FIG. 13, referring to FIG. 14, the apparatus for audio processing 130 further includes a response module 134 configured to: in response to a drag operation of dragging a target timbre control of the one or more timbre controls to a second voice part control of the one or more voice part controls, adjust a timbre of a second vocal associated with the second voice part control to a timbre corresponding to the target timbre control; and display, based on the drag operation, a drag animation associated with the drag operation, wherein the drag animation includes an animation of the timbre control.

According to one or more embodiments of the present disclosure, the response module 134 is specifically configured to: in response to the drag operation, display an animation of the timbre control; and control the animation of the timbre control to move along a drag trajectory associated with the drag operation.

According to one or more embodiments of the present disclosure, the response module 134 is specifically configured to: in response to a sliding operation on the acoustic phase control, adjust an acoustic phase of a second vocal associated with the voice part control.

According to one or more embodiments of the present disclosure, the generating module 132 is specifically configured to: determine, based on the first vocal, a harmony melody associated with the third voice part; and generate the second vocal of the third voice part based on the first vocal and the harmony melody.

According to one or more embodiments of the present disclosure, the generating module 132 is specifically configured to: obtain an accompaniment chord associated with the first vocal; and adjust, based on the third voice part, the accompaniment chord to obtain the harmony melody associated with the second voice part of the third voice part.

According to one or more embodiments of the present disclosure, the generating module 132 is specifically configured to: in accordance with a determination that a pitch difference between a pitch associated with the harmony melody and a first pitch of the first vocal is less than or equal to a first threshold, tune the first vocal to the harmony melody to obtain the second vocal of the third voice part; and in accordance with a determination that the pitch difference between the pitch associated with the harmony melody and the first pitch is greater than the first threshold, translate the pitch associated with the harmony melody to a position of the first pitch, and tuning the first vocal to the harmony melody to obtain the second vocal of the third voice part.

According to one or more embodiments of the present disclosure, the generating module 132 is specifically configured to: tune the first vocal to the harmony melody to obtain a vocal to be processed, wherein a timbre of the vocal to be processed is the same as a timbre of the first vocal; and obtain a predetermined timbre and replacing the timbre of the vocal to be processed with the predetermined timbre to obtain the second vocal of the third voice part.

According to one or more embodiments of the present disclosure, the voice part includes a low voice part, a middle low voice part, a middle voice part, a middle high voice part and a high voice part.

The apparatus for audio processing provided in the embodiments of the present disclosure may be configured to perform the technical solutions of the foregoing method embodiments, and implementation principles and technical effects thereof are similar, and details are not described herein again in this embodiment.

The embodiments of the present disclosure further provide a computer readable storage medium storing computer execution instructions that, when executed by a processor, causes the processor to perform the method according to the foregoing method embodiments.

The embodiments of the present disclosure further provide a computer program, which, when executed by a processor, implements the method described in the foregoing method embodiments.

The embodiments of the present disclosure further provide a computer program product, including a computer program which, when executed by a processor, implements the method described in the foregoing method embodiments.

The present disclosure provides a method, apparatus and electronic device for audio processing, and the method includes: obtaining a first vocal; generating, based on the first vocal, a second vocal of one or more voice parts associated with the first vocal, a timbre of the second vocal being a predetermined timbre; and playing a target audio based on the first vocal and the second vocal of the one or more voice parts, the target audio comprising the first vocal and/or the second vocal of the one or more voice parts. In the above method, when the user finishes singing the first vocal, the electronic device can generate harmonies (second vocal) of multiple voice parts associated with the first vocal, so that the audio of singing without accompaniment can be obtained, the user does not need to perform multiple harmony singing, the user experience is improved, and the complexity of audio obtaining is reduced.

FIG. 15 is a schematic structural diagram of an electronic device according to the embodiments of the present disclosure. FIG. 15 is a schematic structural diagram of an electronic device 1500 suitable for implementing the embodiments of the present disclosure, and the electronic device 1500 may be a terminal device or a server. The terminal device may include, but is not limited to, a mobile terminal such as a mobile phone, a laptop, a digital broadcast receiver, a personal digital assistant (PDA), a Portable Android Device (PAD), a portable multimedia player (PMP), an in-vehicle terminal (for example, a car navigation terminal), and a fixed terminal such as a digital TV, a desktop computer, or the like. The electronic device shown in FIG. 15 is merely an example and should not impose any limitation on the functionality and use ranges of the embodiments of the present disclosure.

As shown in FIG. 15, the electronic device 1500 may include a processing device (for example, a central processing unit or a graphics processor) 1501, and may perform various appropriate actions and processing according to a program stored in a read-only memory (ROM) 1502 or a program loaded into a random-access memory (RAM) 1503 from a storage device 1508. In the RAM 1503, various programs and data required by the operation of the electronic device 1500 are also stored. The processing device 1501, the ROM 1502, and the RAM 1503 are connected to each other through a bus 1504. An input/output (I/O) interface 1505 is also connected to the bus 1504.

Generally, the following devices may be connected to the I/O interface 1505: an input device 1506 including, for example, a touch screen, a touch pad, a keyboard, a mouse, a camera, a microphone, an accelerometer, a gyroscope, etc. ; an output device 1507 including, for example, a liquid crystal display (LCD), a speaker, a vibrator, etc. ; a storage device 1508 including, for example, a magnetic tape, a hard disk, etc. ; and a communication device 1509. The communication device 1509 may allow the electronic device 1500 to communicate wirelessly or wired with other devices to exchange data. Although FIG. 15 illustrates a electronic device 1500 having various devices, it should be understood that all illustrated devices are not required to be implemented or provided. More or fewer devices may alternatively be implemented or provided.

In particular, according to the embodiments of the present disclosure, the process described above with reference to the flowchart may be implemented as a computer software program. For example, embodiments of the present disclosure include a computer program product including a computer program embodied on a computer readable medium, the computer program including program code for performing the method shown in the flowchart. In such embodiments, the computer program may be downloaded and installed from the network through the communication device 1509, or installed from the storage device 1508, or from the ROM 1502. When the computer program is executed by the processing device 1501, the foregoing functions defined in the method of the embodiments of the present disclosure are performed.

It should be noted that the computer readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

The computer readable medium may be included in the foregoing electronic device, or may exist separately, and is not assembled into the electronic device.

The computer readable medium carries one or more programs, and when the one or more programs are executed by the electronic device, the electronic device performs the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. In some cases, the name of a unit does not constitute a limitation on the unit itself. For example, a first obtaining unit may be further described as “obtaining at least two units of Internet Protocol addresses”.

The functions described above may be performed, at least in part, by one or more hardware logic components. For example, without limitation, the example types of hardware logic components that may be used include: a field programmable gate array (FPGA), an application specific integrated circuit (ASIC for short), an application specific standard product (ASSP), a system on chip (SoC for short), a complex programmable logic device (Complex Programmable Logic Device, CPLD for short), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

It should be noted that the modification of “a” and “a plurality” mentioned in this disclosure is illustrative and not limiting, and those skilled in the art should understand that “one or more” should be understood unless the context clearly indicates otherwise.

The names of messages or information exchanged between multiple devices in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as electronic devices, applications, servers, or storage media that perform the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations. The data may include information, parameters, messages, and the like, such as flow cut indication information.

The above description is only the preferred embodiments of this disclosure, and an explanation of the technical principles used. Those skilled in the art should understand that the scope of disclosure referred to in this disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in this disclosure.

Furthermore, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of this disclosure. Some features described in the context of individual embodiments can also be combined and implemented in a single embodiment. On the contrary, various features described in the context of a single embodiment can also be implemented individually or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only example forms of implementing the claims.

1. A method of audio processing, comprising:
obtaining a first vocal;
generating, based on the first vocal, a second vocal of one or more voice parts associated with the first vocal, a timbre of the second vocal being a predetermined timbre; and
playing a target audio based on the first vocal and the second vocal of the one or more voice parts, the target audio comprising the first vocal and/or the second vocal of the one or more voice parts.

2. The method of claim 1, wherein obtaining the first vocal comprises:
displaying an audio obtaining page comprising a recording control and/or an audio import control; and
in response to a touch operation on the recording control or the audio import control, obtaining the first vocal.

3. The method of claim 2, wherein obtaining the first vocal in response to the touch operation on the audio import control comprises:
in response to the touch operation on the audio import control, displaying an audio import page comprising an audio file associated with the first vocal; and
in response to a touch operation on the audio file, obtaining the first vocal.

4. The method of claim 2, wherein obtaining the first vocal in response to the touch operation on the recording control comprises:
in response to a touch operation on the recording control, recording a vocal uttered by a user; and
in response to a touch operation on the recording control, stopping recording the vocal uttered by the user to obtain the first vocal.

5. The method of claim 1, wherein playing the target audio based on the first vocal and the second vocal of the one or more voice parts comprises:
displaying a play page of the first vocal, the play page comprising one or more voice part controls and a play control;
in response to a touch operation on the one or more voice part controls, displaying, based on a first display mode, the one or more voice part controls; and
in response to a touch operation on the play control, playing the target audio comprising the first vocal and the second vocal associated with the one or more voice part controls.

6. The method of claim 5, wherein, when playing the target audio, the method further comprises:
in response to a touch operation on a first voice part control displayed in the first display mode, displaying, based on a second display mode, the first voice part control, wherein the target audio does not comprise a second vocal associated with the first voice part control, and a display brightness of the second display mode is lower than a display brightness of the first display mode.

7. The method of claim 5, wherein the play page comprises one or more timbre controls; the method further comprises:
in response to a drag operation of dragging a target timbre control of the one or more timbre controls to a second voice part control of the one or more voice part controls, adjusting a timbre of a second vocal associated with the second voice part control to a timbre corresponding to the target timbre control; and
displaying, based on the drag operation, a drag animation associated with the drag operation, wherein the drag animation comprises an animation of the target timbre control.

8. The method of claim 7, wherein displaying the drag animation associated with the drag operation based on the drag operation comprises:
in response to the drag operation, displaying an animation of the target timbre control; and
controlling the animation of the target timbre control to move along a drag trajectory associated with the drag operation.

9. The method of claim 5, wherein the play page comprises an acoustic phase control associated with the voice part control, the method further comprising:
in response to a sliding operation on the acoustic phase control, adjusting an acoustic phase of a second vocal associated with the voice part control.

10. The method of claim 1, wherein for any third voice part of the one or more voice parts, generating the second vocal of the third voice part associated with the first vocal based on the first vocal comprises:
determining, based on the first vocal, a harmony melody associated with the third voice part; and
generating the second vocal of the third voice part based on the first vocal and the harmony melody.

11. The method of claim 10, wherein determining the harmony melody associated with the second vocal of the third voice part based on the first vocal comprises:
obtaining an accompaniment chord associated with the first vocal; and
adjusting, based on the third voice part, the accompaniment chord to obtain the harmony melody associated with the second voice part of the third voice part.

12. The method of claim 10, wherein generating the second vocal of the third voice part based on the first vocal and the harmony melody comprises:
in accordance with a determination that a pitch difference between a pitch associated with the harmony melody and a first pitch of the first vocal is less than or equal to a first threshold, tuning the first vocal to the harmony melody to obtain the second vocal of the third voice part; and
in accordance with a determination that the pitch difference between the pitch associated with the harmony melody and the first pitch is greater than the first threshold, translating the pitch associated with the harmony melody to a position of the first pitch, and tuning the first vocal to the harmony melody to obtain the second vocal of the third voice part.

13. The method of claim 12, wherein tuning the first vocal to the harmony melody to obtain the second vocal of the third voice part comprises:
tuning the first vocal to the harmony melody to obtain a vocal to be processed, wherein a timbre of the vocal to be processed is the same as a timbre of the first vocal; and
obtaining a predetermined timbre and replacing the timbre of the vocal to be processed with the predetermined timbre to obtain the second vocal of the third voice part.

14. The method of claim 1, wherein the voice part comprises a low voice part, a middle low voice part, a middle voice part, a middle high voice part and a high voice part.

15. (canceled)

16. An electronic device, comprising: a processor and a memory;
the memory storing computer executable instructions;
the processor executing the computer executable instructions stored in the memory, so that the processor performs acts of audio processing, the acts comprising:
obtaining a first vocal;
generating, based on the first vocal, a second vocal of one or more voice parts associated with the first vocal, a timbre of the second vocal being a predetermined timbre; and
playing a target audio based on the first vocal and the second vocal of the one or more voice parts, the target audio comprising the first vocal and/or the second vocal of the one or more voice parts.

17. A non-transitory computer readable storage medium storing computer executable instructions which, when a processor executes the computer executable instructions, implement acts of audio processing, the acts comprising:
obtaining a first vocal;
generating, based on the first vocal, a second vocal of one or more voice parts associated with the first vocal, a timbre of the second vocal being a predetermined timbre; and
playing a target audio based on the first vocal and the second vocal of the one or more voice parts, the target audio comprising the first vocal and/or the second vocal of the one or more voice parts.

18. (canceled)

19. (canceled)

20. The device of claim 16, wherein obtaining the first vocal comprises:
displaying an audio obtaining page comprising a recording control and/or an audio import control; and
in response to a touch operation on the recording control or the audio import control, obtaining the first vocal.

21. The device of claim 20, wherein obtaining the first vocal in response to the touch operation on the audio import control comprises:
in response to the touch operation on the audio import control, displaying an audio import page comprising an audio file associated with the first vocal; and
in response to a touch operation on the audio file, obtaining the first vocal.

22. The device of claim 20, wherein obtaining the first vocal in response to the touch operation on the recording control comprises:
in response to a touch operation on the recording control, recording a vocal uttered by a user; and
in response to a touch operation on the recording control, stopping recording the vocal uttered by the user to obtain the first vocal.

23. The device of claim 16, wherein playing the target audio based on the first vocal and the second vocal of the one or more voice parts comprises:
displaying a play page of the first vocal, the play page comprising one or more voice part controls and a play control;
in response to a touch operation on the one or more voice part controls, displaying, based on a first display mode, the one or more voice part controls; and
in response to a touch operation on the play control, playing the target audio comprising the first vocal and the second vocal associated with the one or more voice part controls.
